(19) United States
(12) Patent Application Publication
(10) Pub. No.: US 2010/0100410 A1
(43) Pub. Date: Apr. 22, 2010

(54) Systems and Methods for Ecological Evaluation and Analysis of an Enterprise

(76) Inventors: Elizabeth S. McPhail, San Diego, CA (US); Lon Daniel McPhail, San Diego, CA (US); Mark O'Donnel, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 12/539,533

(22) Filed: Aug. 11, 2009

Related U.S. Application Data
(60) Provisional application No. 61/087,983, filed on Aug. 11, 2008.

(51) Int. Cl. G06Q 10/00; G06Q 50/00

(52) U.S. Cl. 705/8; 705/7

(57) ABSTRACT

Systems and methods are described that improve, optimize and measure enterprise and consumer ecological sustainability, including use and disposal of energy, water, chemicals and waste thereof. Systems comprise combinations of networks, processors, software and analytics techniques, methodologies and technology. Systems and methods extend business intelligence through breakthrough mapping, integration, and modeling technologies to assess and expose the elements that contribute to ecological sustainability.

### CROSS-REFERENCE TO RELATED APPLICATIONS

The present Application claims priority from U.S. Provisional Patent Application No. 61/087,983 filed Aug. 11, 2008, which is incorporated by reference herein in its entirety.

### BACKGROUND OF THE INVENTION

1. Field of the Invention

The present invention relates generally to enterprise software and analytics and more particularly to corporate performance management and business intelligence as it relates to the sustainability of the entity.

2. Description of Related Art

Currently deployed business intelligence and business analytics technologies have limited mapping, integration, and predictive modeling abilities. Most companies currently focus on the past and have piecemeal information to make decisions. Today's business intelligence technology can bring parts of the enterprise into focus but falls short of allowing full understanding of the holistic business organism. For example, a national car rental company with $15B in fleet trying to minimize its fleet inventory (e.g. identifying $800m in savings) while maximizing revenue. There is a need to model the factors of demand coupled with exigent and dynamic market conditions (e.g. conferences, major migration patterns, etc.). In this case the business intelligence insights are those into the measure of sustainability and green performance of an entity.

Business performance management (BPM) is a process by which enterprises, companies, entities, corporations, and/or businesses attempt to optimize their business performance. This is typically accomplished by the use of a framework for organizing, automating and analyzing business methodologies, metrics, processes and systems that drive business performance. The ability to analyze business data has been made complex by the incompatibility or lack of communication between diverse business systems. However, the use of sophisticated software tools has allowed enterprises to mine data and to analyze it with an eye to improving performance. In this case the business intelligence insights are those into the measure of sustainability and green performance of an entity.

One of the keys in BPM is the ability to define and measure performance metrics. Once these measurables are defined, benchmarks are established so that the effect of changes to the operation of the enterprise can be measured. The use of BPM is often needed even to identify these key metrics before further analysis and optimization can take place. For some businesses, these metrics may include customer population numbers, (including turnover, acquisition of new customers, and status of existing customers), financial markers, debt indicators, demographic analysis, delinquency of payments/invoices; and other factors. In this case the BPM insights are those into the measure of sustainability and green performance of an entity.

One area where businesses are attempting to monitor performance is in the arena of ecological performance. A business may find it necessary or desirable to improve its “green” performance. A problem has been the way to monitor such green performance.

Attempts to provide solutions in this area come from two separate environments; 1) the Business Intelligence/Business Analytics technologies, and 2) the Information Technology space, with key related technologies and art in this space as identified as follows:
Business Intelligence software and capabilities which collect, synthesize, and display business performance and financial data.
Server/Datacenter concentration sites which consider how green values will decrease their operational costs when making product or component purchase decisions.

### BRIEF SUMMARY OF THE SYSTEM

Certain embodiments of the invention comprise systems that provide enterprise and consumer ecological sustainability including energy, water, waste, etc. (hereinafter referred to as “GREEN”) software and analytics processes, methodologies, and technology, hereinafter referred to as “Luminosity Green”. This Art extends the reach of Business Performance Management (BPM) and business intelligence (BI) through breakthrough mapping, integration, and modeling technologies to assess and expose the elements that contribute to GREEN and the reduction of same into a quantifiable GREEN rating for a given enterprise, consumer or person, hereinafter sometimes referred to as “ENTITY”.

The system of Methodologies, Tools and Processes for the Mapping and Dynamic Modeling of GREEN properties within a given ENTITY is comprised of two (2) parts and when combined with Luminosity Mapper and Luminosity Green an aggregation of these two components, hereinafter sometimes referred to as “Luminosity System”, yields additional and greater capabilities than that which the components yield independently.

Luminosity Green™ facilitates the mathematical analysis of mapped GREEN factors/metrics, modeling, and visual rendering of same in a manner that facilitates robust understanding of an ENTITY's GREEN condition while also allowing operators to evaluate alternative hypothetical GREEN scenarios to improve their overall GREEN status.

Luminosity Mapper™ facilitates the identification and mapping of factors and metrics to ENTITY data from the top level to the field level to raw inputs; facilitates understanding of data/information systems and precisely where drivers used for decision making reside both within internal and external sources; captures relationships between the factors and metrics; captures periodicity (creation and frequency); captures data touch points (creation source, assembly source, etc.); amongst other numerous factors.

The application of this technology is summarized as a software and analytics capability focused on extending the GREEN condition of an ENTITY through breakthrough integration, mapping and modeling technologies.

### BRIEF DESCRIPTION OF THE DRAWINGS

FIG. 1 illustrates Luminosity Green Product Concept.

FIG. 2 illustrates Luminosity Green's main Functional capabilities.

FIG. 3 illustrates Luminosity Green Product benefit delivery to customer roles.

FIG. 4 illustrates Luminosity Green's Logical Breakdown and one possible embodiment.

FIG. 5 illustrates Operational Outputs in an example of how financial impacts are considered when making GREEN related decisions.

FIG. 6 illustrates operational representation of the type and level of data a user could obtain when drilling down into a specific area of interest.

FIG. 7 illustrates Luminosity Green's organization logic.

FIG. 8 illustrates possible Activities and their Business Benefits.

FIG. 9 illustrates Cumulative Business Benefit against Cost and GREEN Rating.

FIG. 10 illustrates Luminosity Green's Risk and Opportunity Identification.

FIG. 11 illustrates Luminosity Green's Opportunity assessment logic with one possible embodiment concept.

FIG. 12 illustrates Luminosity Green's Opportunity assessment logic with one possible embodiment concept (2 of 3).

FIG. 13 illustrates Luminosity Green's Opportunity assessment logic with one possible embodiment concept (3 of 3).

FIG. 14 illustrates a GREEN score.

FIG. 15 illustrates Luminosity Green's global reporting initiative management as illustrated through a possible embodiment with LEED, and another through GRI.

FIG. 16 illustrates Luminosity Green's management of Climate exchange data.

FIG. 17 illustrates Luminosity Green's Carbon Market Exchange Methodology as illustrated through one possible embodiment.

FIG. 18 illustrates GREEN score scaled for different business verticals.

FIG. 19 illustrates GREEN score framework for creating a vertical average.

FIG. 20 illustrates Luminosity Green's Scoring Logic.

FIG. 21 illustrates a typical system employed in certain embodiments of the invention.

### DETAILED DESCRIPTION OF THE SYSTEM

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise systems that provide enterprise and consumer ecological sustainability including energy, water, waste, etc. (hereinafter referred to as “GREEN”) software and analytics processes, methodologies, and technology, hereinafter referred to as “Luminosity Green”. Certain embodiments extend the reach of Business Performance Management (“BPM”) and business intelligence (“BI”) through breakthrough mapping, integration, and modeling technologies to assess and expose the elements that contribute to GREEN and the reduction of same into a quantifiable GREEN rating for a given enterprise, consumer or person, hereinafter sometimes referred to as “ENTITY”.

Methodologies, tools and processes according to certain aspects of the invention, used for mapping and dynamic modeling of GREEN properties within a given ENTITY, may comprise two parts and, when combined with Luminosity Mapper and Luminosity Green, an aggregation of these two components, collectively referred to herein as “Luminosity System,” yields additional and greater capabilities than that which the components yield independently.

In one example, Luminosity Green™ facilitates the mathematical analysis of mapped GREEN factors/metrics, modeling, and visual rendering of same in a manner that facilitates robust understanding of an ENTITY's GREEN condition while also allowing operators to evaluate alternative hypothetical GREEN scenarios to improve their overall GREEN status. Luminosity Mapper™ facilitates the identification and mapping of factors and metrics to ENTITY data from the top level to the field level to raw inputs; facilitates understanding of data/information systems and precisely where drivers used for decision making reside both within internal and external sources; captures relationships between the factors and metrics; captures periodicity (creation and frequency); captures data touch points (creation source, assembly source, etc.); amongst other numerous factors.

The application of this technology can be summarized as a software and analytics capability focused on extending the GREEN condition of an ENTITY through breakthrough integration, mapping and modeling technologies. Luminosity Mapper and Luminosity Green, coupled with optimization models and their related tools and capabilities, together and/or independently integrate GREEN data—regardless of the number and type of systems—using software, systems, and ontology to enable decoding and making accessible information related to an entity's GREEN status. This enables; a) empirically understanding of the GREEN status of an Entity's operation, b) agile GREEN-improving operational decisions, and c) systemic and mathematically optimized GREEN performance.

The underlying factors of strategic and tactical decision-making relating to GREEN are often complex. Entities typically have many systems, such as Oracle, SAS, and SAP, that are used to accomplish a small subset of the capabilities outlined herein. In one example, Luminosity Mapper and Luminosity Green (while not limited in any way to these systems or any other systems implied or inferred) regardless of target data source(s), can possess independent and combined capabilities designed to decode an Entity's GREEN information maze, placing a user in control of even the most complicated Entity's GREEN model. It will be appreciated that GREEN impacts are connected in ways that are not always obvious. Simply, an Entity's GREEN positions can be modeled and simulated to enlighten decision-making and, in turn, systemically optimize GREEN performance. Entities that employ these tools will have a competitive advantage.

Because most entities do not operate within a single system, certain aspects of the Luminosity System provide capabilities that permit the user to readily traverse a heterogeneous multi-system environment to calculate, model, and to assess its GREEN attributes. These capabilities additionally help companies gain further value out of their data warehouse and business intelligence (BI) investments, whereas the existence of these pre-existing capabilities can be further added to the Claimed capabilities to augment and enhance the overall Capabilities. Luminosity Green resolves issues associated with prior systems by accreting GREEN data into a robust runtime analytics model.

This holistic understanding of the enterprise's GREEN attributes, their status, and an Entity's sphere of influence is important to gaining control of the causal relationship set of how to manage and control an Entity's GREEN status. Consequently GREEN attributes and status provided according to certain aspects of the invention extend beyond a small number of key performance indicators. Capabilities provided by certain embodiments of the invention can harness data from heterogeneous system environments (derived from sources internal to an Entity and from external feeds obtained from providers of GREEN influencing services) and direct input, making all pertinent data available to standardized and customized models that are harnessed within the Luminosity System.

In certain embodiments of the invention, users can gain value and insight into their GREEN status because these capabilities assist in understanding, measuring, simulating and optimizing their GREEN performance while understanding, quantifying, valuing, and ranking mitigating business value related to the Entity's GREEN footprint. Systems constructed according to certain aspects of the invention assist in transforming the quality of the GREEN decision support information such that users of these capabilities will routinely have greatly improved intelligence and therefore make better and more informed choices and thus elicit optimized GREEN performance.

### Notional Examples of Partial Implementation Using Luminosity Mapper & Luminosity Modeler

### Example 1

For each ENTITY and business vertical, a mean ‘average’ score for the GREEN value set is computed and the subcomponents and aggregates are then computed and scored based on their relationship to the most relevant peer universe or a ‘vertical average.’

### Example 2

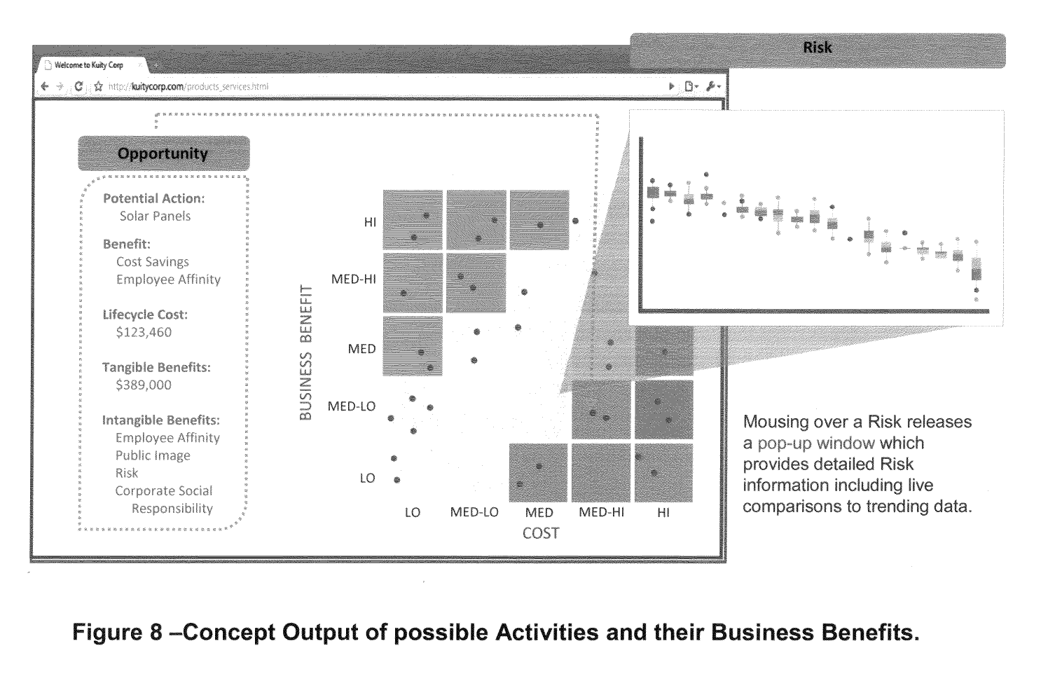

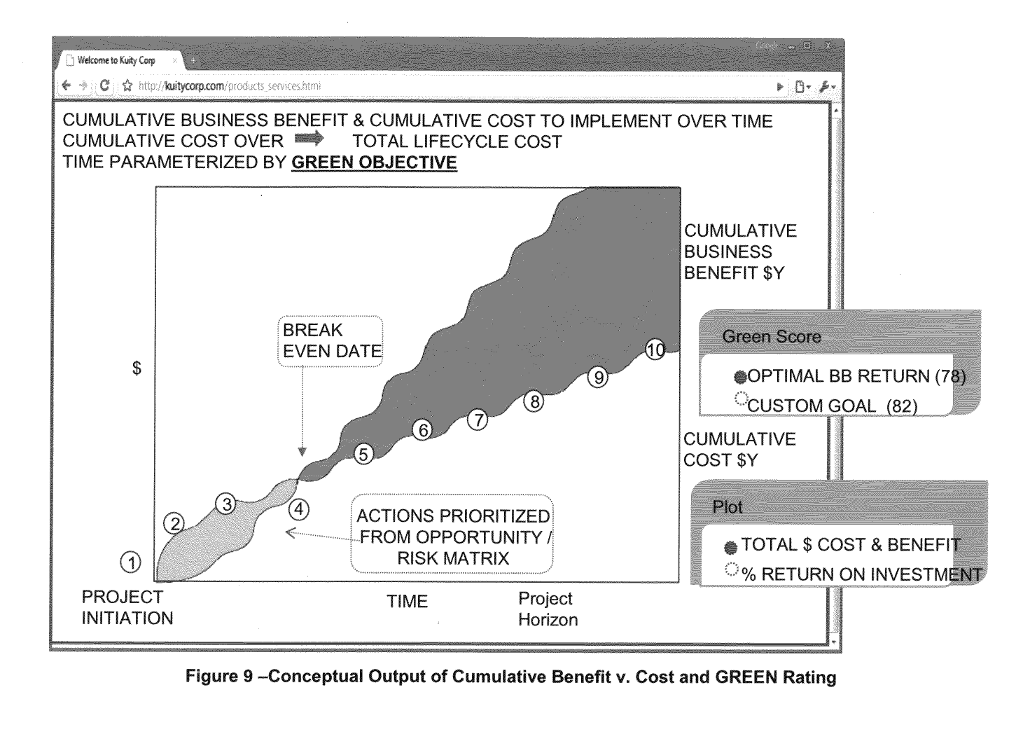

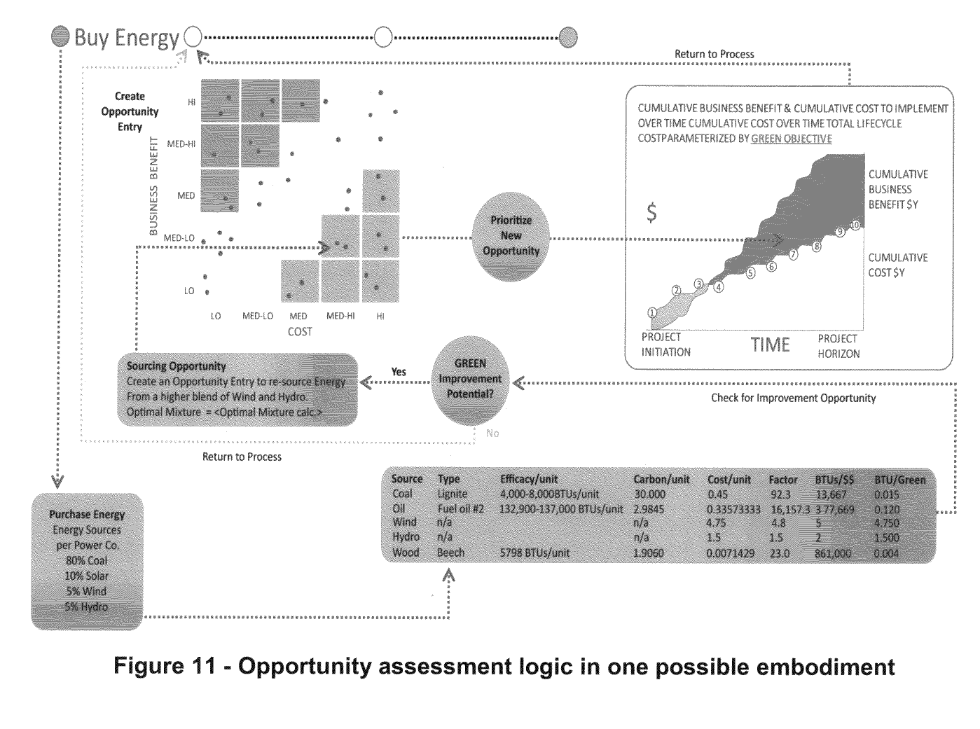

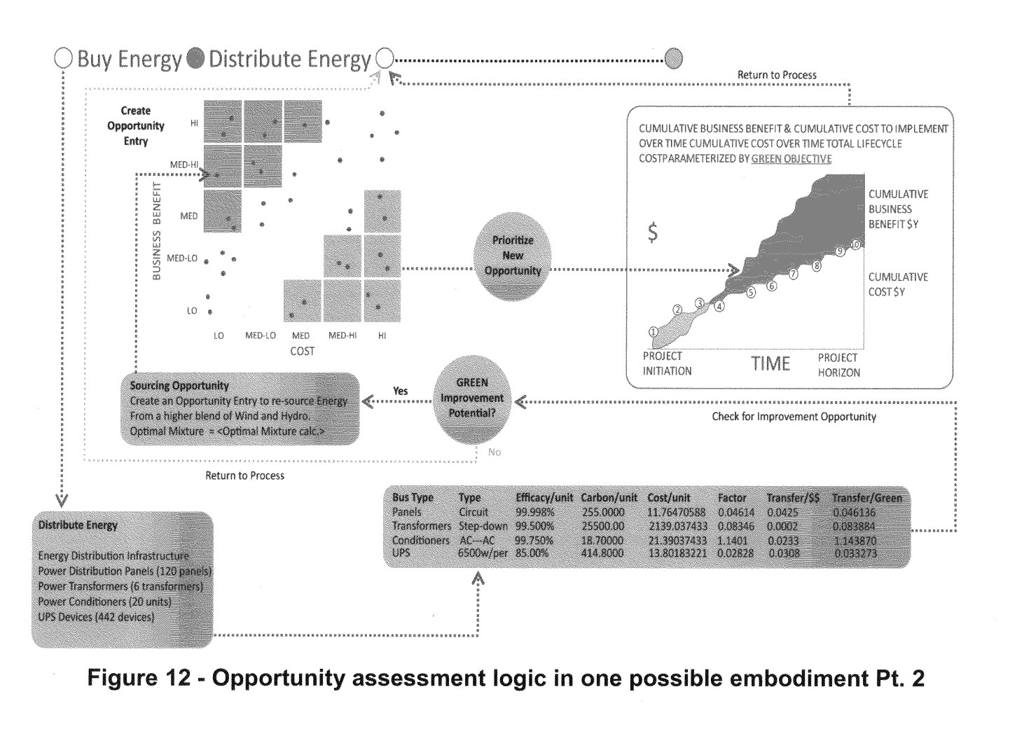

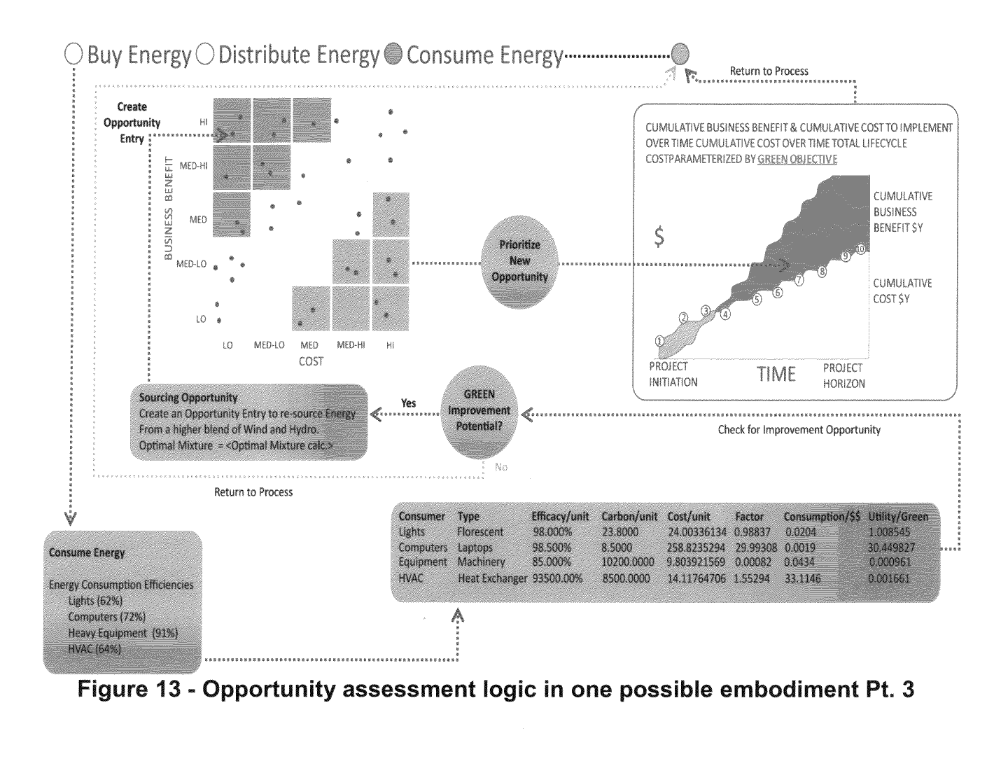

Cumulative business benefit and cumulative investment cost over stated time horizon are made available. As seen in FIG. 9, during the ‘red’ region, enterprises are ‘in the red’ while investing in GREEN. In the GREEN region, enterprises are reaping rewards from their GREEN investments. Circles representing the actions as prioritized from FIG. 8 are based on a calculation of an optimal order as seen in FIG. 11-13. Ability to plot total value of cost and benefit, or plot % return on investment are available. These could result in very different plots. In fact a % ROI could be maximized by doing only the first recommended action. It is the goal to model synergies across actions and some of the multiplicative effects as an ENTITY becomes more GREEN.

### Example 3

The Luminosity System can determine and plot a plan for an ‘optimal’ GREEN score. Certain actions yield better GREEN outcomes. These may or may not be tied to the optimal overall business value return on investment; however, these actions may yield a higher GREEN score. While the default output will plot the optimal overall business value vs. cost plan, an option may be provided to override the default and enter a revised default to maximize GREEN. It is contemplated that some ENTITIES will be motivated by altruism and, accordingly, a custom goal can be entered, a desired GREEN score can be dialed-in and the Luminosity System will produce a plan or otherwise demonstrate how these objectives may be accomplished. Typically, if the enterprise opts for less GREEN, costs should decrease, as should the return. If the enterprise selects more GREEN, cost will increase somewhat and optimal return may not be obtained on the additional investment.

### Example 4

Scale and the effect of actions over time is an important consideration and reveals the cumulative effect of investments over time. The graphs show a series of ‘knees’ with each one labeled with an action (circle). On the time axes, each circle coincides with the completion of the action. The ENTITY will spend up the cost curve while implementation takes place, and then flatten out until the start of the next action. The Enterprise will implement the action, then see the return. Some sets of actions may be completed in parallel and may perhaps shorten the time to increased benefits.

### Orientation Markers

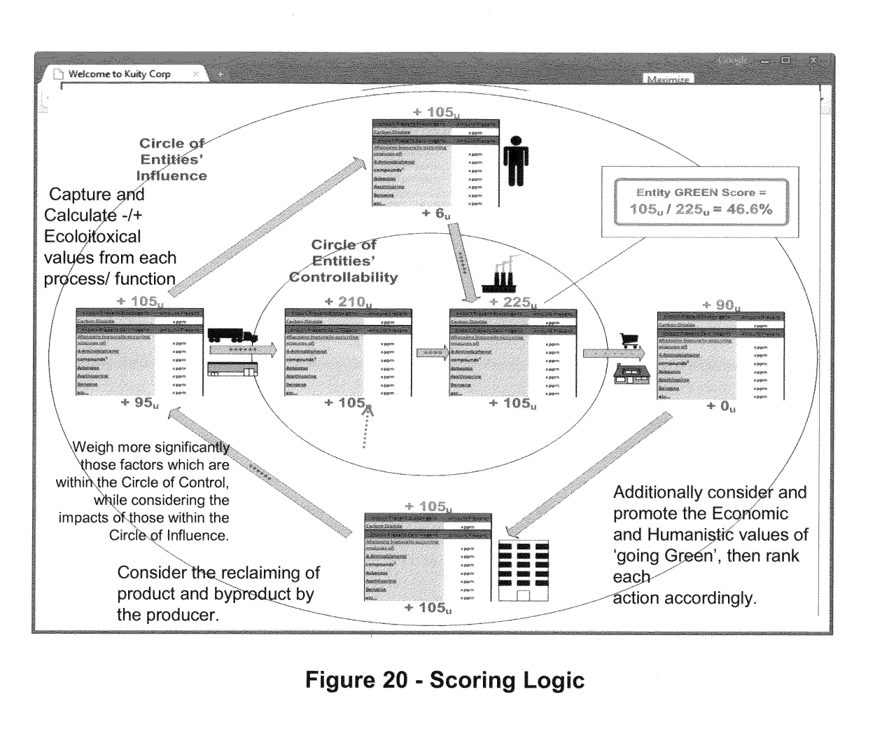

FIG. 20 is a representation of Luminosity Green's scoring logic. In one embodiment, the system divides an enterprise into a plurality of actors. These actors can represent other entities, sub-entities, personnel, activities, materiel, or other definable actors. These actors are characterized into two groups, a circle of controllability and a circle of influence. In the example of FIG. 20, the system captures and calculates ecologitoxical values from each actor. The system weighs factors within the circle of controllability higher than those factors within the circle of influence. Other factors are considered (e.g. economic and humanistic values of going green) and those factors are ranked accordingly.

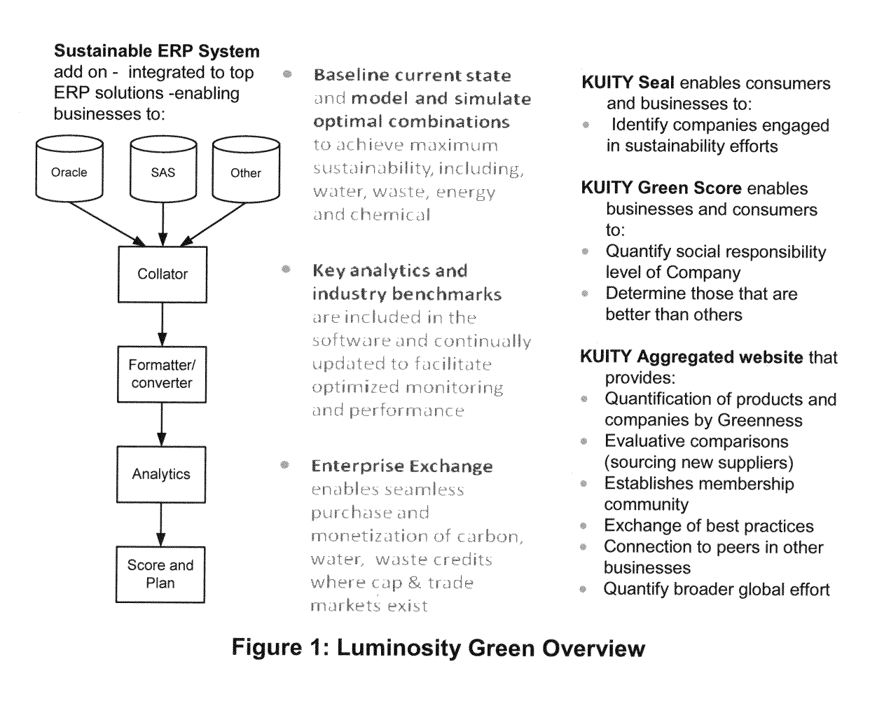

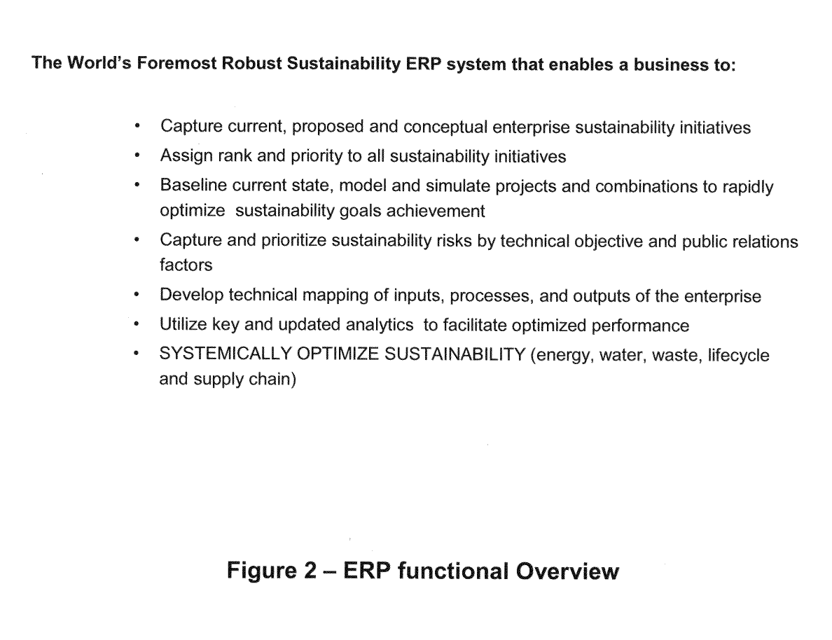

FIG. 1 and FIG. 2 are a description of some of the Luminosity Green product concept offerings in one embodiment of the system. These include, by way of example, enterprise software for base-lining a current state, simulation models and analytics. The system includes tools to monetize factors such as carbon/water/waste credits or the purchase of credits. The system contemplates a branded certification of meeting a minimum level of effort or accomplishment in green activities. An Enterprise Green Score that can be meaningfully compared to other enterprises.

FIG. 8 is an example of one system output showing the relationship between possible activities (i.e. solar panels) and the associated business benefits.

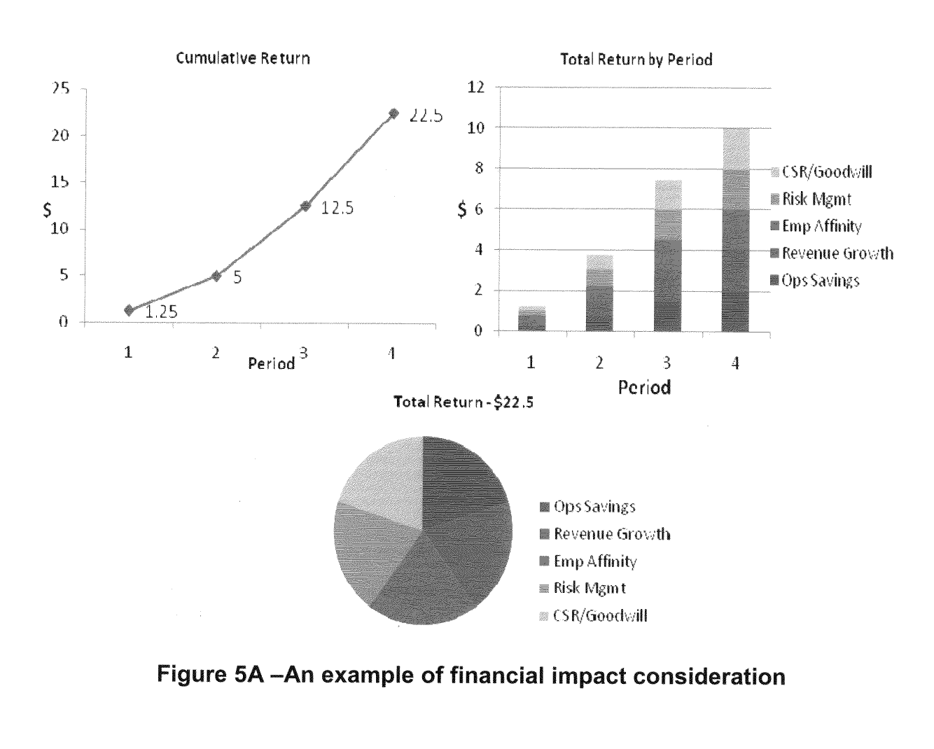

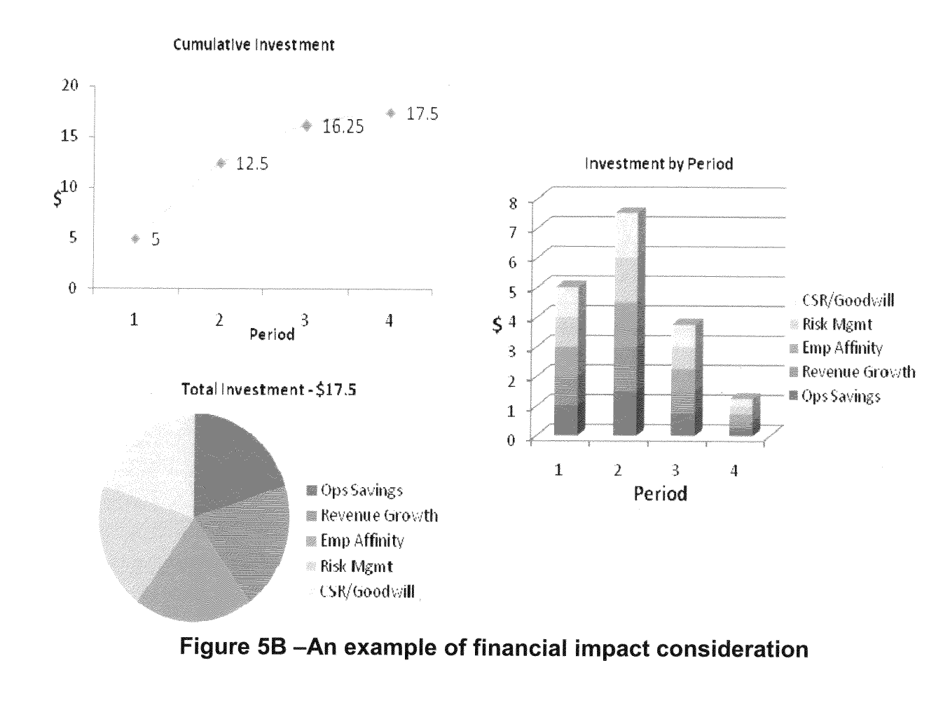

FIG. 5 is an example of financial impacts when making GREEN related decisions. The top graph is return while the bottom graph is investment. The system permits actual tracking of these metrics as well as the ability to generate projections prior to decision making to determine paths which will yield desired results.

Reporting is an important part of the system. Heterogeneous data must be extracted, processed, and analyzed to give accurate reporting and to determine if predicted relationships are causal or merely correlated. If so, updating of system analytics and relationships may be required. The system allows for closed-loop fine-tuning of the process.

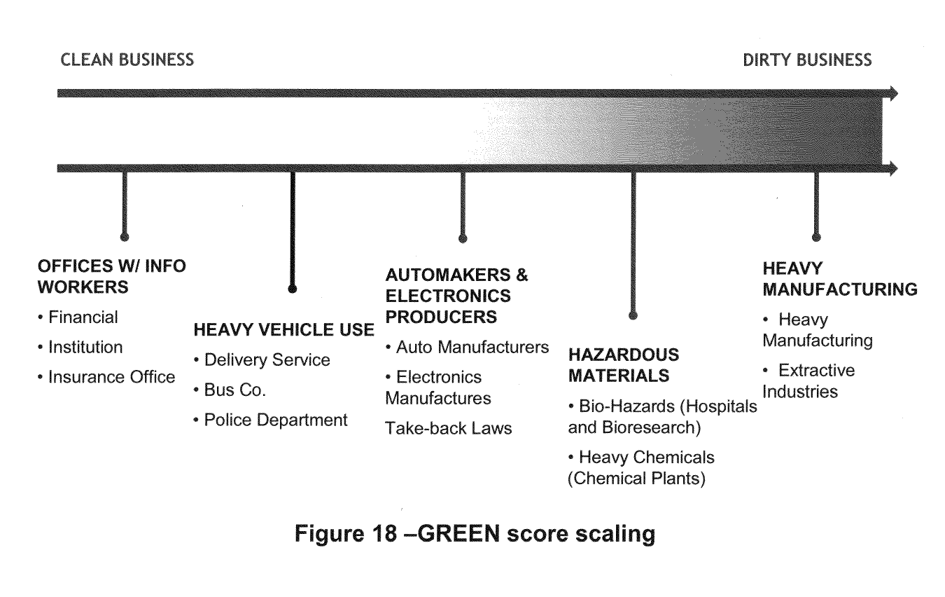

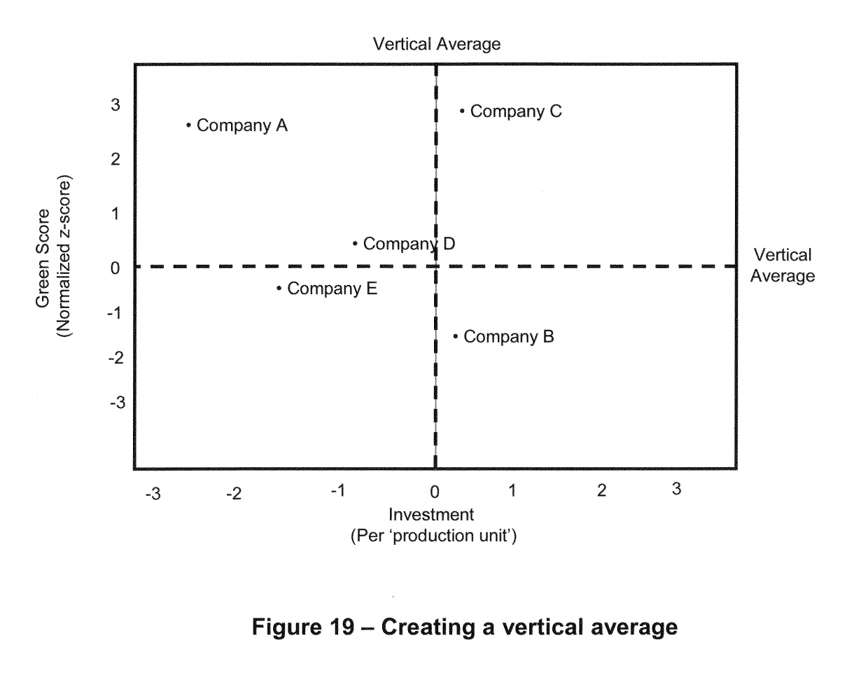

FIG. 19 is a graphical example of one embodiment of a GREEN score that can be standardized for all enterprises, within an industry, or customized for an individual enterprise. In one embodiment, it is contemplated that an enterprise will use this standards based GREEN scoring system in publicity, advertising, and other reporting. FIG. 18 is an example of GREEN scores for different business verticals. This allows an enterprise to compare themselves to similar enterprises. Finally, FIG. 19 presents GREEN scores normalized by industry so that meaningful comparisons can be made.

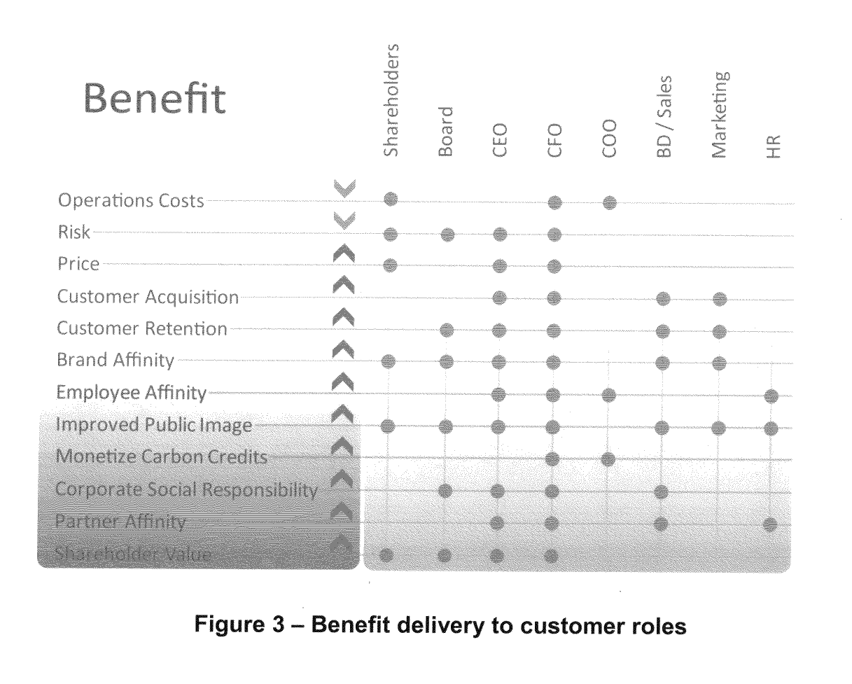

FIG. 3 is a matrix of business benefit to Luminosity GREEN Capabilities, and how they relate.

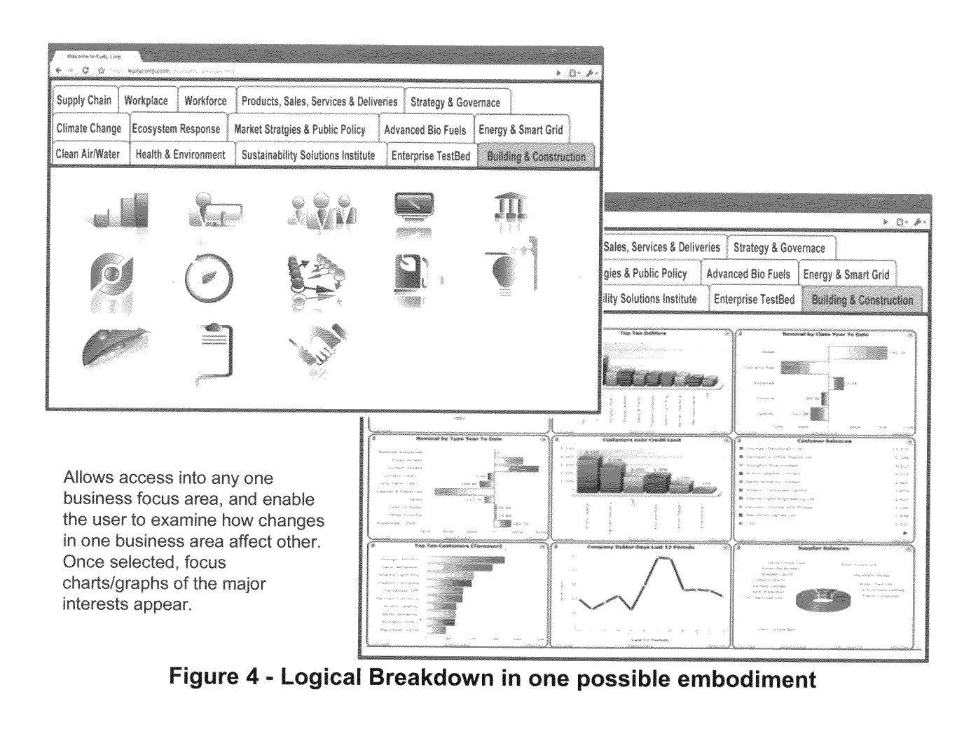

FIG. 4 is one embodiment of a graphical user interface enabling system operators to navigate throughout the multiple sustainability verticals and concerns.

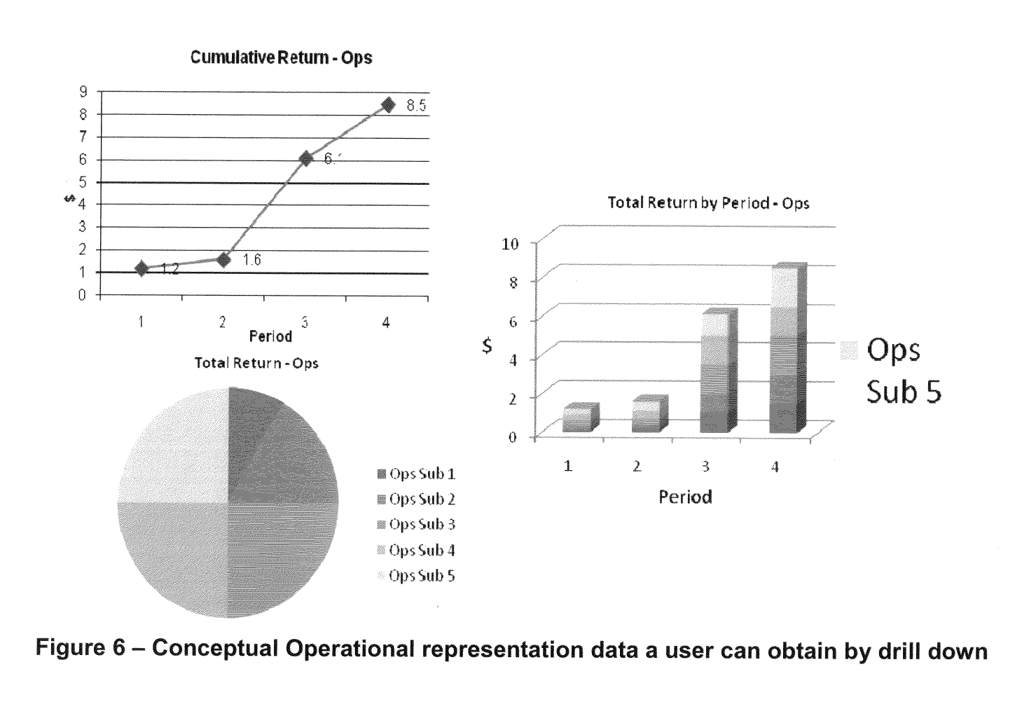

FIG. 6 is one embodiment of the continuation of visibility into the discrete trending costs/benefits as detailed in FIG. 5.

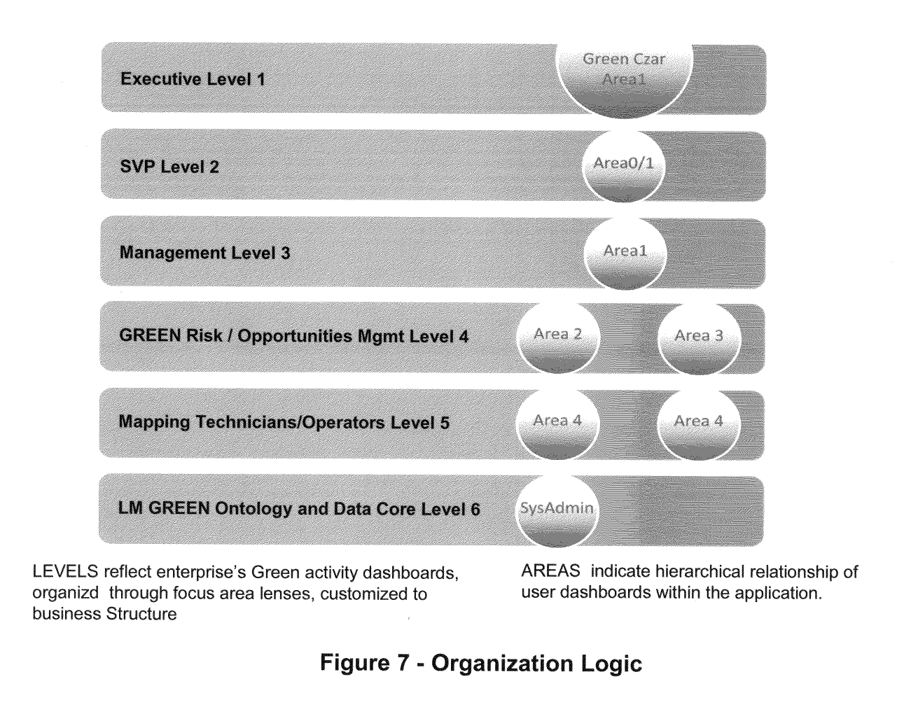

FIG. 7 is a depiction of the Luminosity GREEN system architecture levels as they possibly relate to the levels of enterprise concern. FIG. 7 is logically a permissions default description and a description of one embodiment.

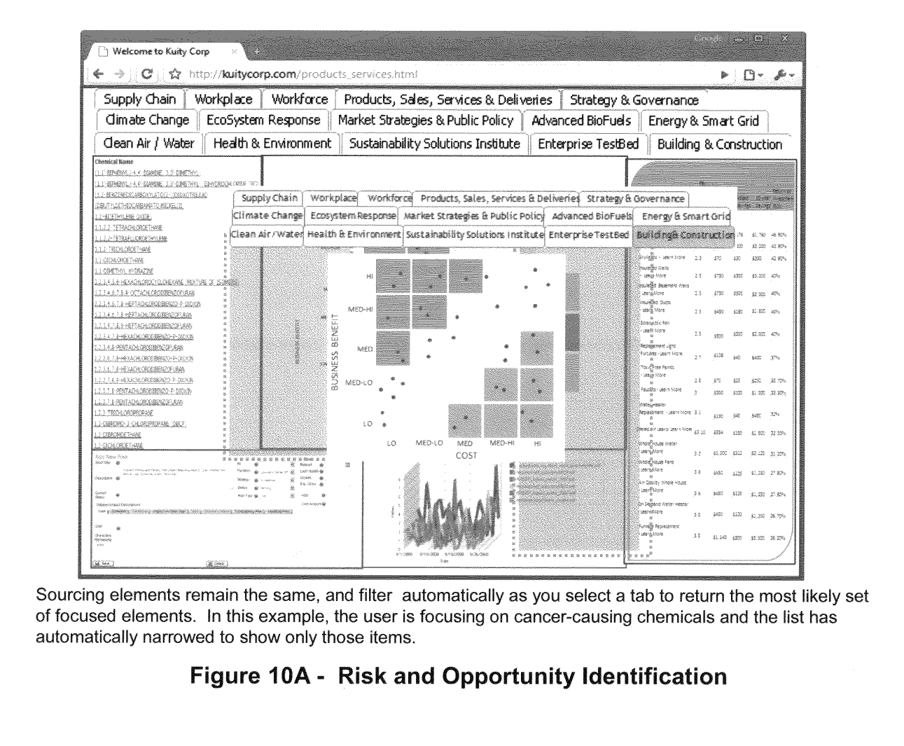

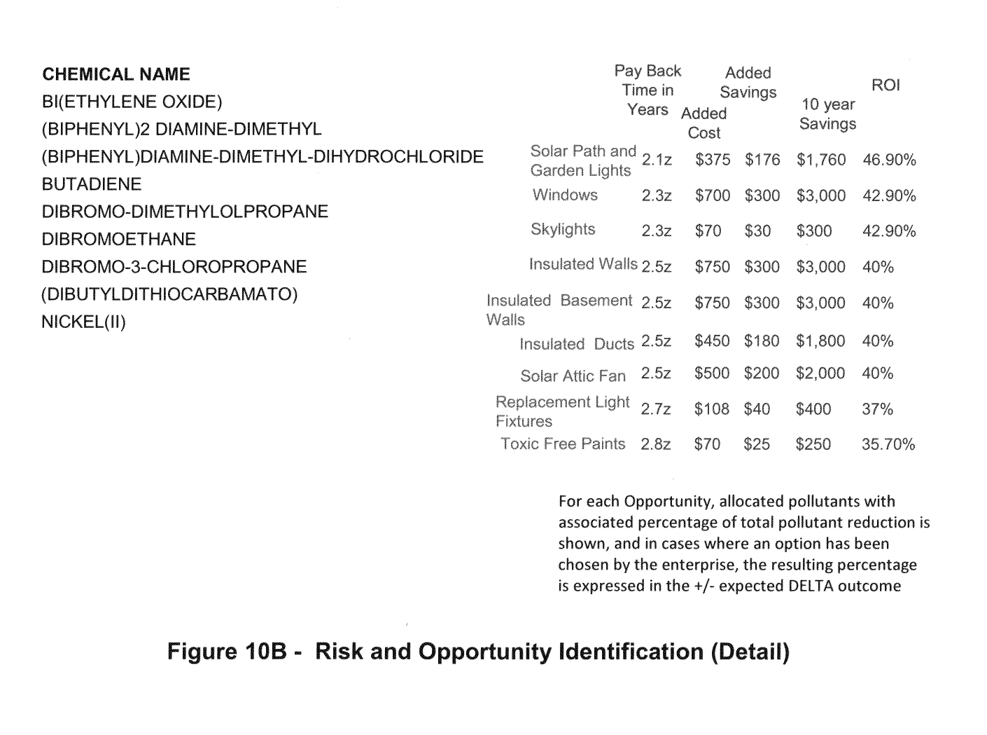

FIG. 10 is a depiction of one embodiment of the enterprise materials mapping functions which maps material inputs-to-outputs. In the one embodiment shown, chemicals being brought into the enterprise, which are known carcinogens, are being mapped to their individual enterprise output methodologies in order to calculate enterprise sustainability.

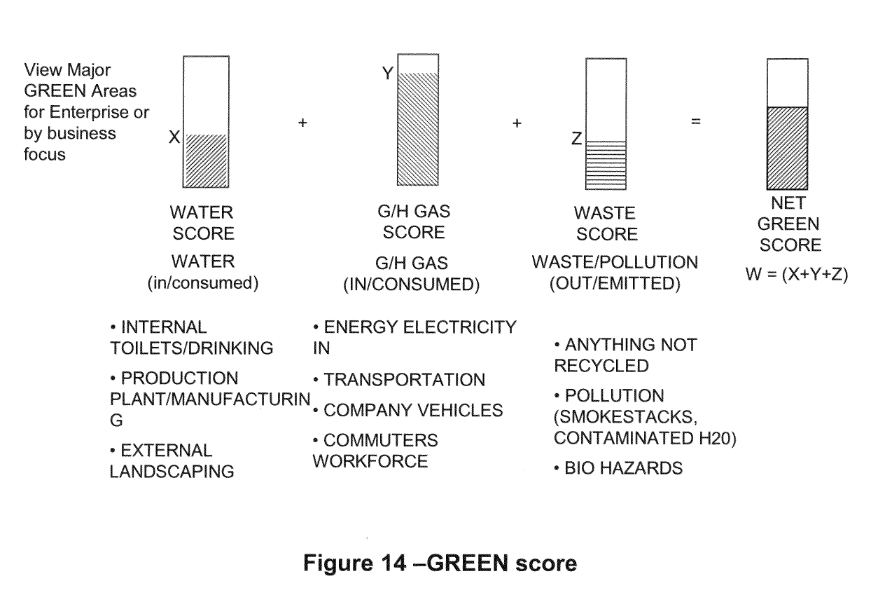

FIG. 14 is one embodiment of a user-level report which gives high-level visibility into the current sustainability index (calculated).

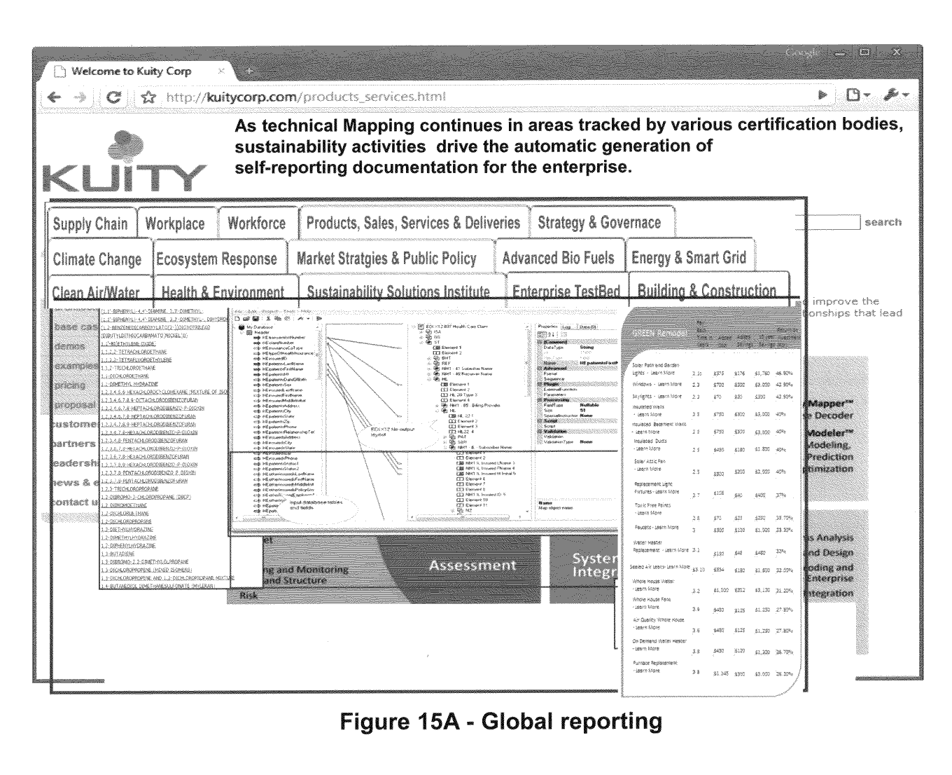

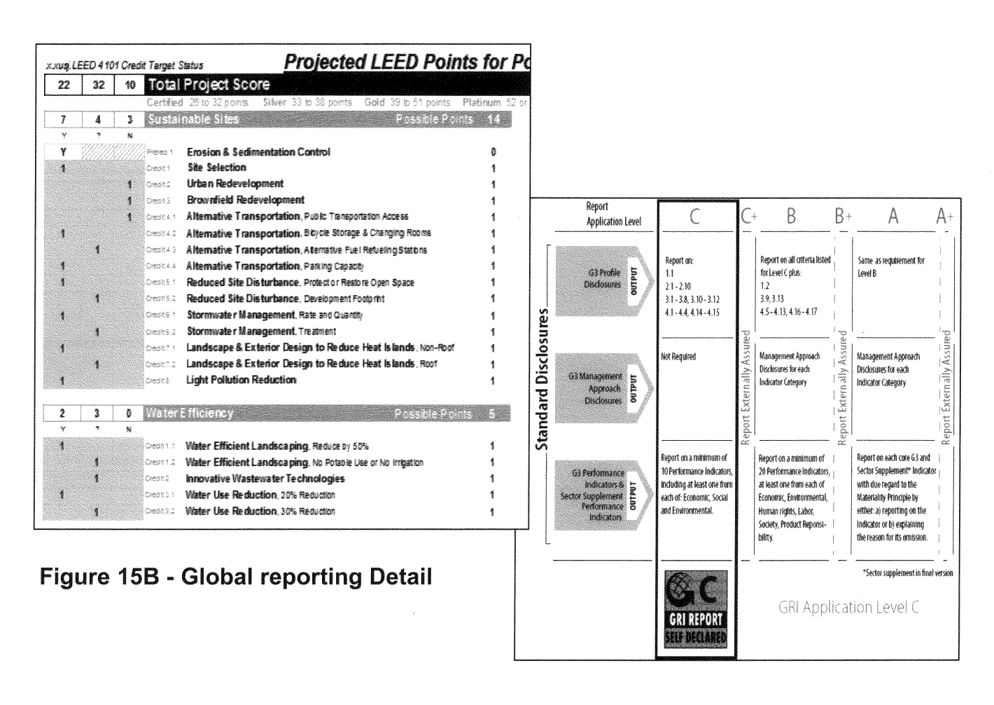

FIG. 15 is one embodiment of Luminosity GREEN's ability to derive current LEED and GRI index status from the current mapping of the indicated enterprise sustainability.

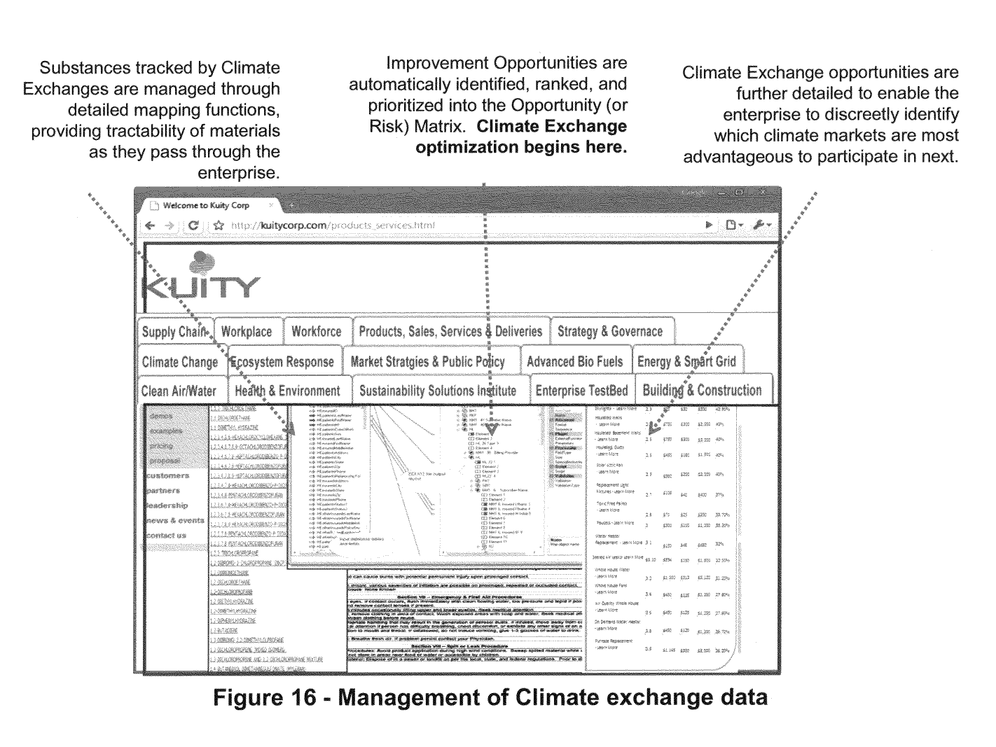

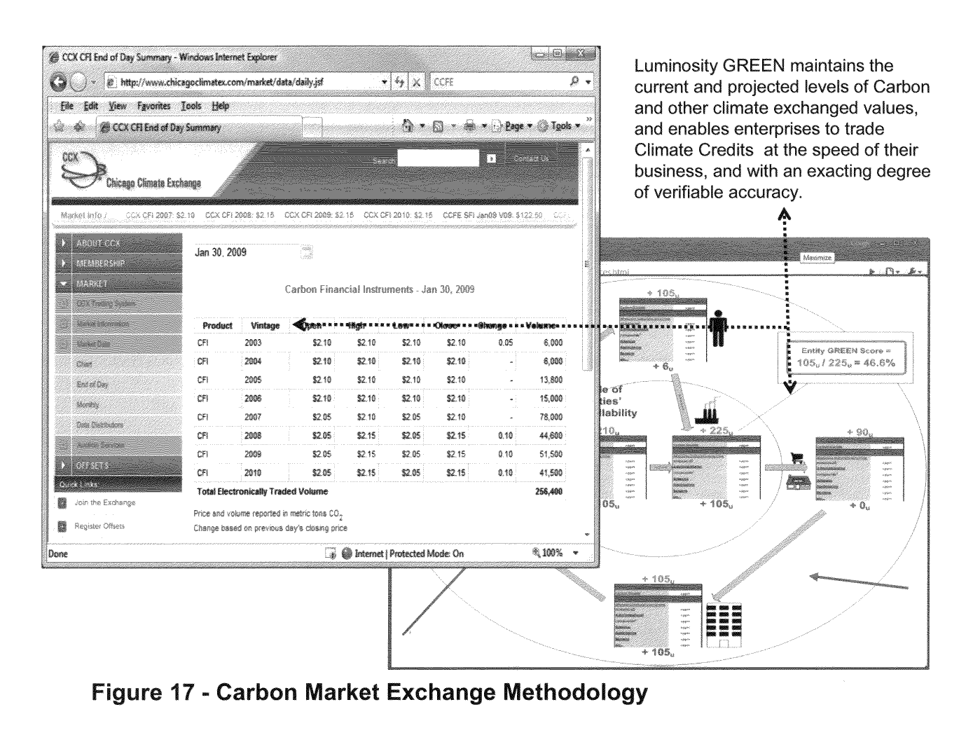

FIG. 16 is a depiction of one embodiment of Luminosity GREEN's capability to manage Climate Exchange Data, facilitating interoperability with Carbon Markets as further depicted in FIG. 17 as one possible embodiment.

### System Description

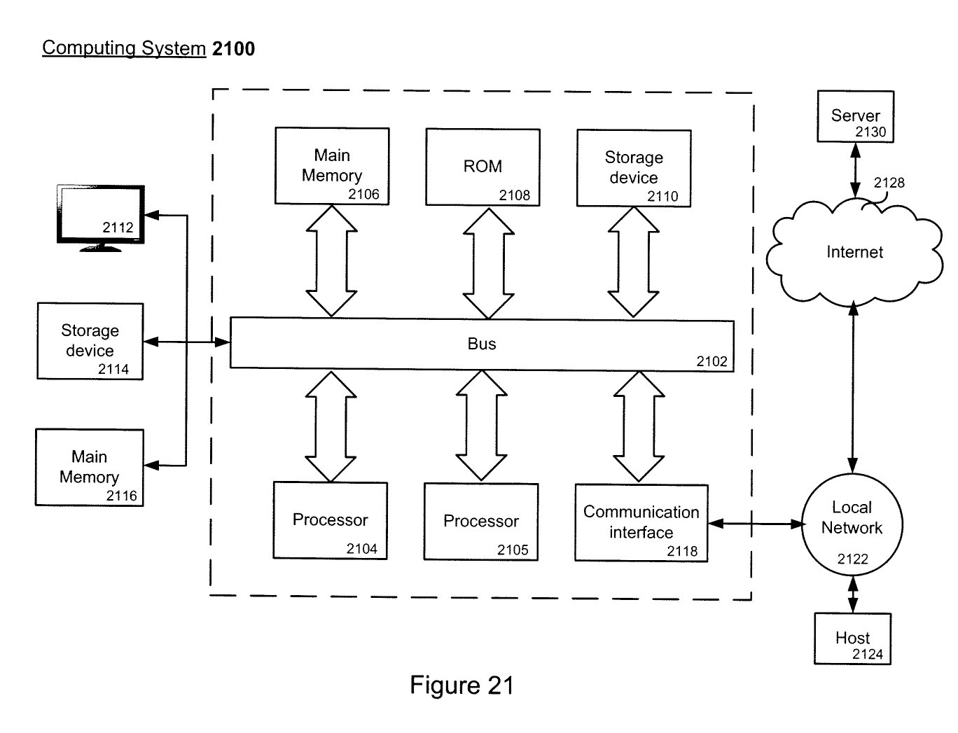

Turning now to FIG. 21, certain embodiments of the invention employ one or more processing systems that perform various of the above described processes and functions. A processing system can include at least one computer or computing system 2100 typically deployed in a network. Suitable computing systems may be comprise commercially available or custom computers that execute commercially available operating systems such as Microsoft Windows®, UNIX or a variant thereof, Linux, a real time operating system and or a proprietary operating system. The architecture of the computing systems may be adapted, configured and/or designed for integration in the processing system, for embedding in one or more of an image capture system, a manufacturing/machining system, a graphics processing workstation and/or a surgical system or other medical management system. In one example, computing system 2100 comprises a bus 2102 and/or other mechanisms for communicating between processors, whether those processors are integral to the computing system 210 (e.g. 2104, 2105) or located in different, perhaps physically separated computing systems 2100.

Computing system 2100 also typically comprises memory 2106 that may include one or more of random access memory (“RAM”), static memory, cache, flash memory and any other suitable type of storage device that can be coupled to bus 2102. Memory 2106 can be used for storing instructions and data that can cause one or more of processors 2104 and 2105 to perform a desired process. Main memory 2106 may be used for storing transient and/or temporary data such as variables and intermediate information generated and/or used during execution of the instructions by processor 2104 or 2105. Computing system 2100 also typically comprises non-volatile storage such as read only memory (“ROM”) 2108, flash memory, memory cards or the like; non-volatile storage may be connected to the bus 2102, but may equally be connected using a high-speed universal serial bus (USB), Firewire or other such bus that is coupled to bus 2102. Non-volatile storage can be used for storing configuration, and other information, including instructions executed by processors 2104 and/or 2105. Non-volatile storage may also include mass storage device 2110, such as a magnetic disk, optical disk, flash disk that may be directly or indirectly coupled to bus 2102 and used for storing instructions to be executed by processors 2104 and/or 2105, as well as other information.

Computing system 2100 may provide an output for a display system 2112, such as an LCD flat panel display, including touch panel displays, electroluminescent display, plasma display, cathode ray tube or other display device that can be configured and adapted to receive and display information to a user of computing system 2100. In that regard, display 2112 may be provided as a remote terminal or in a session on a different computing system 2100. In certain embodiments, results may be used to control automated systems, including purchasing systems, manufacturing control systems, HVAC, plant management and other systems. An input device 2114 is generally provided locally or through a remote system and typically provides for alphanumeric input as well as cursor control 2116 input, such as a mouse, a trackball, etc. It will be appreciated that input and output can be provided to a wireless device such as a PDA, a tablet computer or other system suitable equipped to display the images and provide user input.

In one example according to one embodiment of the invention, processor 2104 executes one or more sequences of instructions. For example, such instructions may be stored in main memory 2106, having been received from a computer-readable medium such as storage device 2110. Execution of the sequences of instructions contained in main memory 2106 causes processor 2104 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 2104 and/or 2105, particularly where the instructions are to be executed by processor 2104 and/or 2105 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 2104 and 2105 or remotely, typically by use of network connection. Non-volatile storage may be removable from computing system 2104, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 2100. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 2104 and/or 2105. For example, the instructions may initially be retrieved from a magnetic disk of a remote computer and transmitted over a network or modem to computing system 2100. The instructions may optionally be stored in a different storage or a different part of storage prior to or during execution.

Computing system 2100 may include a communication interface 2118 that provides two-way data communication over a network 2120 that can include a local network 2122, a wide area network or some combination of the two. For example, an integrated services digital network (ISDN) may used in combination with a local area network (LAN). In another example, a LAN may include a wireless link. Network link 2120 typically provides data communication through one or more networks to other data devices. For example, network link 2120 may provide a connection through local network 2122 to a host computer 2124 or to a wide are network such as the Internet 2128. Local network 2122 and Internet 2128 may both use electrical, electromagnetic or optical signals that carry digital data streams.

Computing system 2100 can use one or more networks to send messages and data, including program code and other information. In the Internet example, a server 2130 might transmit a requested code for an application program through Internet 2128 and may receive in response a downloaded application that provides for the anatomical delineation described in the examples above. The received code may be executed by processor 2104 and/or 2105.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for optimizing resource usage in an enterprise. Some of these embodiments comprise a collator for collecting information associated with operations of the enterprise from a plurality of subsystems. Some of these embodiments comprise a formatter for converting the collected information to a common format. Some of these embodiments comprise an analyzer for identifying interactions between certain of the plurality of subsystems that affect a measured characteristic of enterprise operation based on the formatted information. Some of these embodiments comprise an optimizer that optimizes the measured characteristic to obtain a desired level of performance of the enterprise by reconfiguring at least one the plurality of subsystems, wherein the desired level of performance relates to management of resources of the enterprise. In some of these embodiments, the plurality of subsystems control resource usage by the enterprise. In some of these embodiments, the plurality of subsystems includes an accounting system. In some of these embodiments, the plurality of subsystems includes a purchasing system. In some of these embodiments, the plurality of subsystems includes a decision support system. In some of these embodiments, the resources include waste and the desired level of performance relates to waste management. In some of these embodiments, the resources include chemicals and the waste includes chemical waste. In some of these embodiments, the resources include chemicals and the desired level of performance relates to pollution control. In some of these embodiments, the resources include energy and the desired level of performance relates to energy usage. In some of these embodiments, the resources include water and the desired level of performance relates to water usage.

Certain embodiments of the invention provide methods for measuring, scoring and for optimizing performances and resource usage in an enterprise. Some of these embodiments comprise obtaining information associated with an enterprise from a plurality of sources. Some of these embodiments comprise transforming the information to obtain formatted data. Some of these embodiments comprise orchestrating the formatted data. Some of these embodiments comprise determining relationships between portions of the formatted data to obtain business intelligence related to the sustainability of the enterprise. Some of these embodiments comprise performing a plurality of analytics on the formatted data and sustainability business intelligence. In some of these embodiments, results of the determining relationships and performing analytics steps are provided to a visualizer configured to produce one or more reports. In some of these embodiments, the plurality of sources includes one or more of a repository of information obtained from one or more systems of the enterprise. In some of these embodiments, the one or more systems include an accounting system. In some of these embodiments, the one or more systems include a purchasing system. In some of these embodiments, the one or more systems includes a decision support system. In some of these embodiments, the plurality of sources includes an external data source that is maintained separately from the enterprise.

In some of these embodiments, the step of transforming the information includes selectively categorizing the information. In some of these embodiments, the step of transforming the information includes selectively sorting the information. In some of these embodiments, the step of transforming the information includes transforming the information to obtain information in a predetermined format. In some of these embodiments, the predetermined format comprises an XML format. In some of these embodiments, the information is obtained using one or more of an SQL call and an RSS feed. In some of these embodiments, the results are employed by one or more tools, the tools comprising a sustainability analyzer, a mapper, a reporter, a modeler, a gateway, a proofing tool, a trend analysis tool, a historical tool, an audit tool, a process mapper and a process optimization tool.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A system for optimizing resource usage in an enterprise, comprising:
a collator for collecting information associated with operations of the enterprise from a plurality of subsystems;
a formatter for converting the collected information to a common format;
an analyzer for identifying interactions between certain of the plurality of subsystems that affect a measured characteristic of enterprise operation based on the formatted information; and
an optimizer that optimizes the measured characteristic to obtain a desired level of performance of the enterprise by reconfiguring at least one the plurality of subsystems, wherein the desired level of performance relates to management of resources of the enterprise.

2. The method of claim 1, wherein the plurality of subsystems control resource usage by the enterprise.

3. The method of claim 2, wherein the plurality of subsystems includes an accounting system.

4. The method of claim 2, wherein the plurality of subsystems includes a purchasing system.

5. The method of claim 2, wherein the plurality of subsystems includes a decision support system.

6. The method of claim 1, wherein the resources include waste and the desired level of performance relates to waste management.

7. The method of claim 6, wherein the resources include chemicals and the wastes includes chemical waste.

8. The method of claim 1, wherein the resources include chemicals and the desired level of performance relates to pollution control.

9. The method of claim 1, wherein the resources include energy and the desired level of performance relates to energy usage.

10. The method of claim 1, wherein the resources include water and the desired level of performance relates to water usage.

11. A method, comprising:
obtaining information associated with an enterprise from a plurality of sources;
transforming the information to obtain formatted data;
orchestrating the formatted data;
determining relationships between portions of the formatted data to obtain business intelligence related to the sustainability of the enterprise; and
performing a plurality of analytics on the formatted data and sustainability business intelligence, wherein results of the determining relationships and performing analytics steps are provided to a visualizer configured to produce one or more reports.

12. The method of claim 11, wherein the plurality of sources includes one or more of a repository of information obtained from one or more systems of the enterprise.

13. The method of claim 12, wherein the one or more systems include an accounting system.

14. The method of claim 12, wherein the one or more systems include a purchasing system.

15. The method of claim 12, wherein the one or more systems includes a decision support system.

16. The method of claim 11, wherein the plurality of sources includes an external data source that is maintained separately from the enterprise.

17. The method of claim 11, wherein the step of transforming the information includes:
selectively categorizing the information;
selectively sorting the information; and
transforming the information to obtain information in a predetermined format.

18. The method of claim 17, wherein the predetermined format comprises an XML format.

19. The method of claim 11, wherein the information is obtained using one or more of an SQL call and an RSS feed.

20. The method of claim 11, wherein the results are employed by one or more tools, the tools comprising a sustainability analyzer, a mapper, a reporter, a modeler, a gateway, a proofing tool, a trend analysis tool, a historical tool, an audit tool, a process mapper and a process optimization tool.
